(19) United States
(12) Patent Application Publication
(10) Pub. No.: US 2008/0168631 A1
(43) Pub. Date: Jul. 17, 2008

(54) Fastener retention clip

(76) Inventor: Derek Lee Cushman, Greenville, MI (US)

Correspondence Address: LAW OFFICES OF JOHN CHUPA & ASSOCIATES, P.C., 28535 ORCHARD LAKE ROAD, SUITE 50, FARMINGTON HILLS, MI, 48334, US

(21) Appl. No.: 11/654,069

(22) Filed: Jan. 17, 2007

(51) Int. Cl. F16B 5/06

(52) U.S. Cl. 24/457

(57) ABSTRACT

A plastic fastener retention clip for pre-assembly attachment and sealing for appliance liners and components without the need of tape. The clip attachment aperture includes an integral wall or barrier that eliminates the need for a secondary taped surface. An interference fit of the retention area ensures proper installation and provides a seal between the liner and the clip. The retention seal and the integral attachment aperture barrier prevent foam from passing through the pre-pierced liner openings during the foaming process. A secondary mechanical fastener may pierce the barrier to attach various appliance components (i.e. shelf brackets, light housings, etc.) to the appliance liner.

### BACKGROUND OF THE INVENTION

The present invention relates to a fastener retention clip for the fastening of various appliance parts/components to an internal or external appliance liner, such as a refrigerator.

Many of the appliance manufacturers utilize a metal stamping that requires two-sided tape attachment, such as shown in U.S. Pat. Nos. 3,298,271, 3,802,476, 4,279,341, 4,293,261, and 4,925,350. This metal stamping is applied/adhered to the inside of the liner and used by the appliance maker to assemble various parts (i.e. shelf brackets, light housings, etc.) to the liner. The liners have a pre-pierced hole that an operator will use to locate one of the metal stampings.

Various sized metal stampings are utilized based on the load requirements of the particular location that a metal stamping is to be used. A metal stamping of greater square area is used in areas where the load requirement is larger. These stampings have a pierced and/or threaded cut out that is used to retain a screw in the assembly process. The metal stampings also have, in most cases, small tabs around the cut out that are used by the operators to align the hole in the stamping to the pre-pierced hole of the liner.

The tape on the part has two functions; to hold the part onto the liner and to stop foam from entering the liner through the pre-pierced holes during the foaming operation. The use of tape requires the removal and disposal of a release paper. The release paper protects the adhesive until removed and requires an operator. The use of adhesive presents possible contamination to the operators work area.

The utilization of the taped metal stampings has various assembly and quality issues that can be minimized and eliminated in some cases by the use of the new fastener retention clip.

Some of the assembly and quality issues that currently exist include the following: locator tabs on parts not lining up with holes, parts being taped to wrong locations, parts dropped to floor will stick to floor, release paper waste removal, parts falling off of liners, tape on parts do not adequately stop foam from entering liners, and parts spinning during screw assembly operation. When a defective liner is discovered, it becomes difficult to recycle the liner due to the stampings being attached to the liners. The stampings, in most cases, have to be removed prior to recycling the liners. If not properly coated and handled the stampings can rust.

### SUMMARY OF THE INVENTION

The Fastener Retention Clip was designed utilizing plastic material to allow for assembly, by either manual or automatic operations, of the clip to the liner material without the need for tape. Through the use of pressure, the clip is retained to the liner by attaching itself through a pre-pierced hole in the liner. There is an interference fit created by the width of the retention portion of the clip, which is slightly greater than the pre-pierced hole in the liner. The clip is designed with tapered/angled walls that keep the clip retained to the liner through the various foaming and assembly operations. The interference fit of the clip to the liner assures that no passage of foam into the liner can occur. Thus the problems associated with the tape are minimized and there is no release paper to be disposed of.

The clip has an aperture(s) or holes in it that will be used for securing the screws in the assembly operation. The apertures do not go thru the entire part. At the base of the part there is a thin wall of material that remains in the bottom portion of the aperture. This material will keep the foam from entering the liner during the foaming operation. The plastic material is thin enough that during the assembly operation the screws that are utilized will cut/push through the material and exit the backside of the clip.

The clip is designed so that the retention area mating with the pre-pierced hole is rectangular so that the part will not spin when the screw is applied. The design of the clip's retention area, as well as the size of the aperture, can be made smaller or larger based on the size of the screw to be utilized. Also, the base of the clip can be made so that a greater or smaller surface area can be available to meet the various applications requirements. The thickness of the base can also be varied to accommodate different thread types.

The type of material used to make the clips, in most cases, can match the material used for making the liners. Color match is possible and the liners made of plastic can be recycled without the need to remove the clips. Since the clips are made of plastic they cannot rust. A wider range of shapes and features can also be offered in plastic over the metal stamped version.

### BRIEF DESCRIPTION OF THE DRAWINGS

FIG. 1 is an isometric view of the liner and clip assembly, illustrating the process of assembly.

FIG. 2 is an isometric view of the retention fastener clip.

FIG. 3 is a cross sectional view of the fastener retention clip.

### DETAILED DESCRIPTION

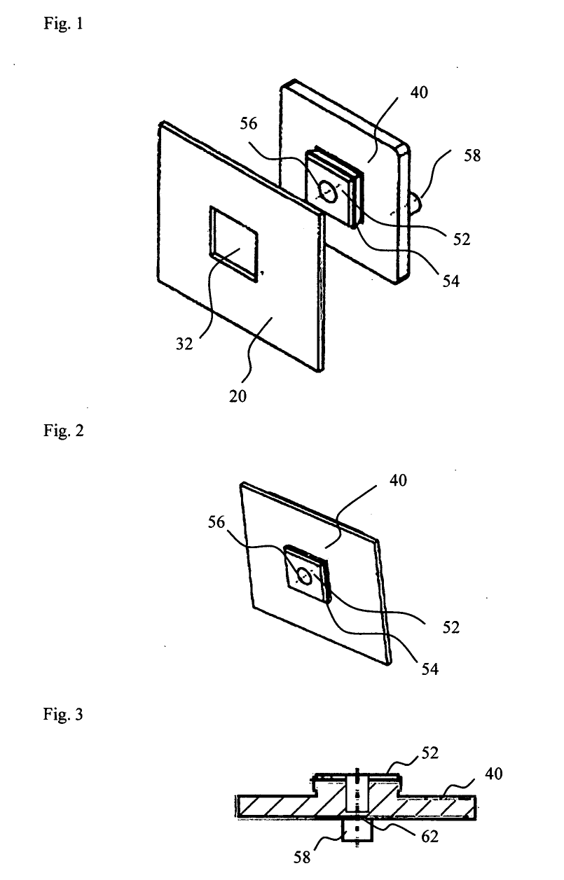

The invention is fastener retention clip that is pre-assembled to an appliance liner, such as a refrigerator liner. The clip provides an attachment means for various appliance components to be attached to the liner at a later stage of assembly. FIG. 1 shows the fastener retention clip 40 and appliance liner 20. The liner includes a pre-pierced hole 32. The fastener clip including a mating retention area 52. The shape of the liner hole and mating retention area can be of any matching geometric shape or keyed shape. The keyed mating retention area can be rotated or slid into a locking position within the liner hole. The retention area including tapered/angled walls 54. The angled walls 54 provide an interference fit when engaged with the liner hole 32. The thickness of the retention area 52 and the angled walls 54 can be modified to meet the fit requirements of the mating liner hole 32. The interference fit provides a seal during the foaming process.

The clip 40 also including an assembly aperture 56 for screw assembly of various appliance components. The assembly aperture 56 is shown centered within the retention area 52 but can be moved to an off center position. The assembly aperture 56 may be threaded, conical, cylindrical or any other shaped as required. The assembly aperture 56 does not pass through the retention clip 20. A thin wall or layer 62 of material closes the aperture 52. This layer provides a barrier during the foaming process of assembly and provides engagement during the screw assembly process. The layer material may be an insert or integrally molded within the retention clip 40. The insert may be of polymeric, elastomeric or metal material. The layer 62 material can be of any depth down to a minimum depth known as flashing when injection molding a part.

The clip may also include a operator assembly tab 58. This assembly tab 58 allows to operator to grip the part for ease of installation and manipulation. The assembly tab 64 doubles as the injection molding gate for the part. This feature may be adjusted or removed as per customer preference.

The fastener retention clip 40 is generally of a polymeric material. The material may be consistent with the liner 20 material to promote recyclability without the requirement to remove the clips.

While the invention has been specifically described in connection with certain specific embodiments thereof, it is to be understood that this is by way of illustration and not of limitation, and the scope of the appended claims should be construed as broadly as the prior art will permit.

1. A fastener retention clip that attaches to an appliance liner including
a mating retention area having an angled edge wall to engage a pre-pierced opening in the liner; and
a screw assembly aperture having a barrier layer of material to prevent foam from exiting aperture.

2. The clip of claim 1 wherein the retention area and pre-pierced liner opening are the same geometric shape.

3. The clip of claim 1 wherein the retention area and the pre-pierced liner opening have a keyed shape.

4. The clip of claim 3 wherein the clip can be rotated to a locking position within the pre-pierced liner.

5. The clip of claim 3 wherein the clip can be slid into a locking position within the pre-pierced liner.

6. The clip of claim 1 wherein the retention area engagement with the liner opening creates a seal to prevent foam exiting during foaming process.

7. The clip of claim 1 wherein the clip is a polymeric material.

8. The clip of claim 7 wherein the clip is a similar material to the liner.

9. The clip of claim 8 wherein the clip and liner can be recycled as one part.

10. The clip of claim 1 wherein the barrier layer is at least the thickness of flashing from the injection molding process.

11. The clip of claim 1 wherein the barrier layer can be penetrated by a mechanical fastener.

12. The clip of claim 11 wherein the mechanical fastener is a screw.

13. The clip of claim 11 wherein the mechanical fastener is a rivet.

14. The clip of claim 11 wherein the mechanical fastener attaches an appliance component to the liner.

15. The clip of claim 14 wherein the appliance component is a shelf bracket.

16. The clip of claim 14 wherein the appliance component is a light housing.

17. A fastener retention clip that attaches a appliance component to an appliance liner which consists of
a mating retention area having an angled edge wall to engage a pre-pierced opening in the liner;
a screw assembly aperture having a barrier layer of material to prevent foam from exiting aperture during the foaming process; and
a mechanical fastener to attach the appliance component to the liner.

18. The clip of claim 17 wherein the retention area and pre-pierced liner opening are the same geometric shape.

19. The clip of claim 17 wherein the retention area and the pre-pierced liner opening have a keyed shape.

20. The clip of claim 19 wherein the clip can be rotated to a looking position within the pre-pierced liner.

21. The clip of claim 17 wherein the retention area engagement with the liner opening creates a seal to prevent foam from exiting during foaming process.

22. The clip of claim 17 wherein the clip is a polymeric material.

23. The clip of claim 17 wherein the clip is a similar material to the liner.

24. The clip of claim 23 wherein the clip and liner can be recycled as one part.

25. The clip of claim 17 wherein the barrier layer is at least the thickness of flashing from the injection molding process.

26. The clip of claim 17 wherein the barrier layer can be penetrated by a mechanical fastener.

27. The clip of claim 26 wherein the mechanical fastener is a screw.

28. The clip of claim 26 wherein the mechanical fastener attached an appliance component to the liner.

29. The clip of claim 28 wherein the appliance component is a shelf bracket.

30. The clip of claim 17 wherein the clip includes an operator assembly tab.

31. The clip of claim 30 wherein the tab is the injection molding gate.
